(19) United States
(12) Patent Application Publication
(10) Pub. No.: US 2009/0050186 A1
(43) Pub. Date: Feb. 26, 2009

(54) DISHWASHER WITH ADJUSTABLE WASH BASKET

(75) Inventors: Jae Yung Kim, Los Angeles, CA (US); Ricardo Barragan, JR., Ontario, CA (US)

Correspondence Address: CONNOLLY BOVE LODGE & HUTZ LLP, P.O. BOX 2207, WILMINGTON, DE, 19899, US

(73) Assignee: DISTINCTIVE APPLIANCES, INC. (dba DACOR)

(21) Appl. No.: 11/845,012

(22) Filed: Aug. 24, 2007

(51) Int. Cl. B08B 13/00

(52) U.S. Cl. 134/165

(57) ABSTRACT

A dishwasher having opposed horizontal slider assemblies employs latches pivotally mounted relative to slide members of the slider assemblies with a handle and a catch. Guides displaced to either side of the latches are affixed to the slide members and include vertical channels for receiving vertical elements included on an elevated wash basket. The vertical elements have upper and lower stops which extend across the slide members, upper and lower glides approaching the opposed walls of the wash cavity at the outer end of the stops and anchors extending inwardly from the glide members and affixed to the wash basket. Latch bolts are also fixed to the sides of the wash basket for engagement by the catches. The wash basket is thereby positionable at more than one vertical location elevated within the wash cavity.

### BACKGROUND OF THE INVENTION

The field of the present invention is automatic dishwashers.

Automatic dishwashers almost universally have an elevated wash basket as well as a bottom wash basket. Such wash baskets typically employ four sides and a bottom with a rack for receiving cups, glasses, plates and the like. The structure of such wash baskets is defined by widely spaced bars made from welded wire that is coated with a noncorroding plastic. The wide spacing of the defining bars allows water spray to penetrate the baskets for washing items loaded within the basket.

Such dishwashers frequently have adjustment mechanisms for the placement of the elevated wash basket in the dishwasher wash cavity. The mechanisms allow adjustment of the height of the elevated wash basket and may allow adjustment to one or both sides. Adjusting mechanisms employed with the basket to adjust the vertical position thereof are subject to repeated wash cycles within the dishwasher, repeated sliding of the basket to and from the wash cavity and repeated adjustments in the vertical position of the basket. As a result, such vertical adjustment mechanisms preferably exhibit durability, repeated actuation and ease of operation. One handed operation is preferred for each side of the basket. Stability and alignment are also design details worthy of consideration to facilitate moving the upper basket in and out of the wash cavity as well as through vertical adjustments.

### SUMMARY OF THE INVENTION

The present invention is directed to a dishwasher including a wash cavity with opposed horizontal slider assemblies, latches operatively mounted relative to a slide member of each of the slider assemblies, guides affixed to the slide members to either side of the latches and an elevated wash basket. The elevated wash basket includes latch bolts to engage catches associated with the latches and vertical elements to slidably engage vertical channels in the guides. A vertically adjustable elevated wash basket results from these components.

In a first separate aspect of the present invention, the vertical elements associated with the wash basket are located adjacent the ends of the sides of the wash basket. The vertical elements have an upper stop extending into the path of travel of the adjacent slide member and an upper glide extending parallel to the adjacent slide member at the extended end of the upper stop. In providing a stop and a glide adjacent the corners of the wash basket sides, stability can be afforded the wash basket.

In a second separate aspect of the present invention, vertical elements associated with the wash basket are located adjacent the ends of the sides of the wash basket. The vertical elements have an upper stop extending into the path of travel of the adjacent slide member and an upper glide extending parallel to the adjacent slide member at the extended end of the upper stop. Additional stops and glides are provided at the bottom of the vertical element to restrict excessive motion from the elevated wash basket and to increase stability as well.

In a third separate aspect of the present invention, vertical elements associated with the wash basket are located adjacent the sides of the wash basket. The vertical elements have an upper stop extending into the path of travel of the adjacent slide member and an upper glide extending parallel to the adjacent slide member at the extended end of the upper stop. Horizontal bars are employed as the latch bolts on the sides of the elevated wash basket to engage the latch. The end portions of the horizontal bars are fixed to the wash basket at multiple locations vertically displaced from one another to gain added strength and stability for the horizontal component of the bars.

In a fourth separate aspect of the present invention, any of the foregoing aspects are contemplated to be employed in combination to greater utility.

Accordingly, it is an object of the present invention to provide an improved automatic dishwasher. Other and further objects and advantages will appear hereinafter.

### BRIEF DESCRIPTION OF THE DRAWINGS

FIG. 1 is a perspective view of a wash basket with the back of a latch mechanism illustrated.

FIG. 2 is a perspective view of a wash basket with the front of a latch mechanism illustrated.

FIG. 3 is a perspective detail of a wash basket illustrating a vertical element.

FIG. 4 is a perspective detail of a vertical element.

FIG. 5 is a top view of a slider assembly with a latch thereon.

FIG. 6 is a side view of the slider assembly of FIG. 5.

FIG. 7 is an end view of the slider assembly of FIG. 5.

### DETAILED DESCRIPTION OF THE PREFERRED EMBODIMENT

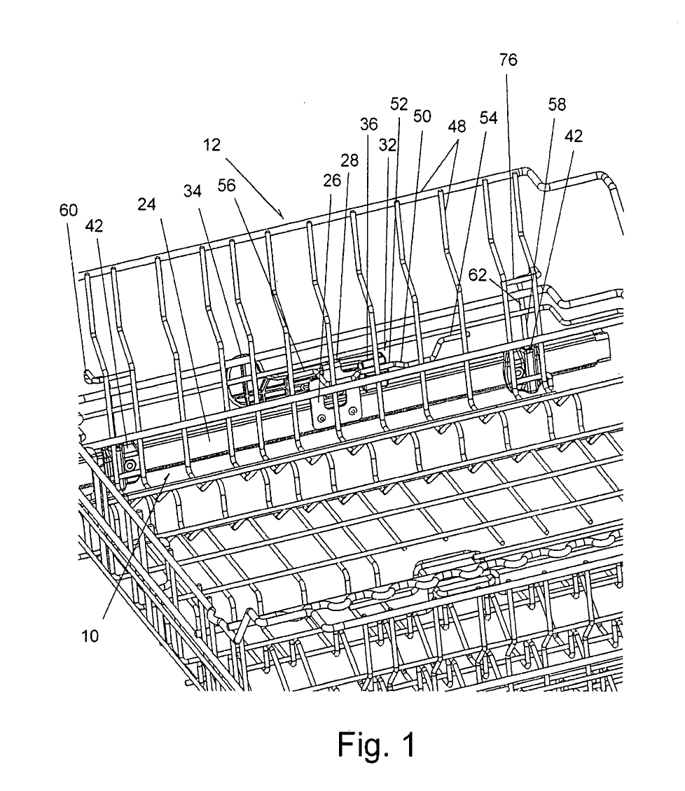

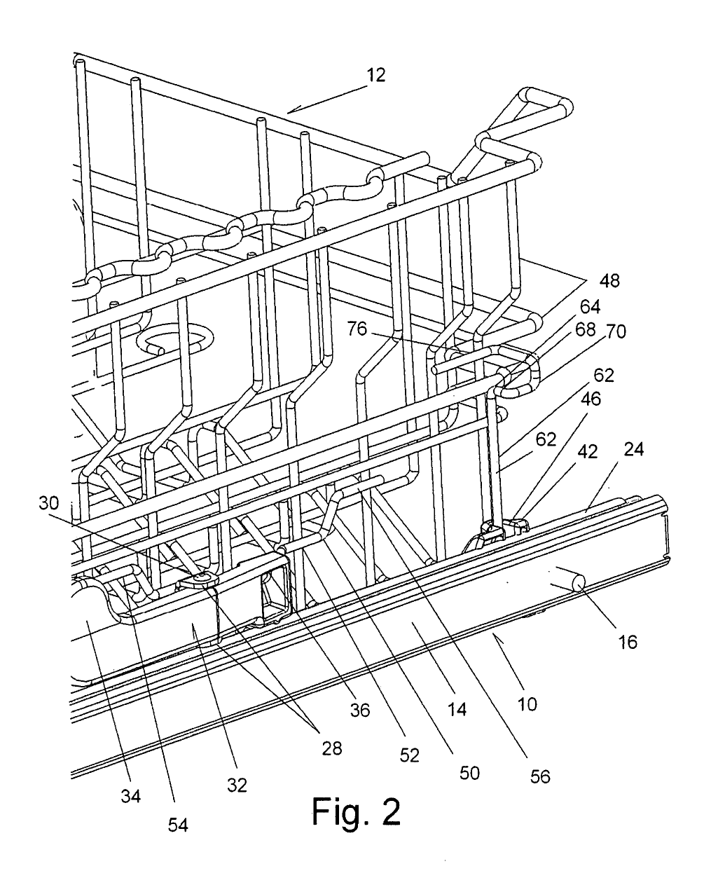

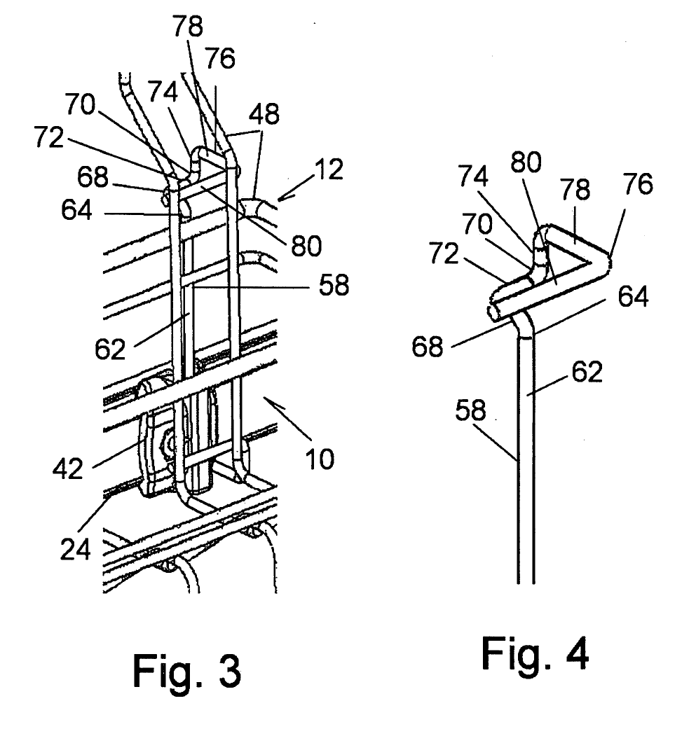

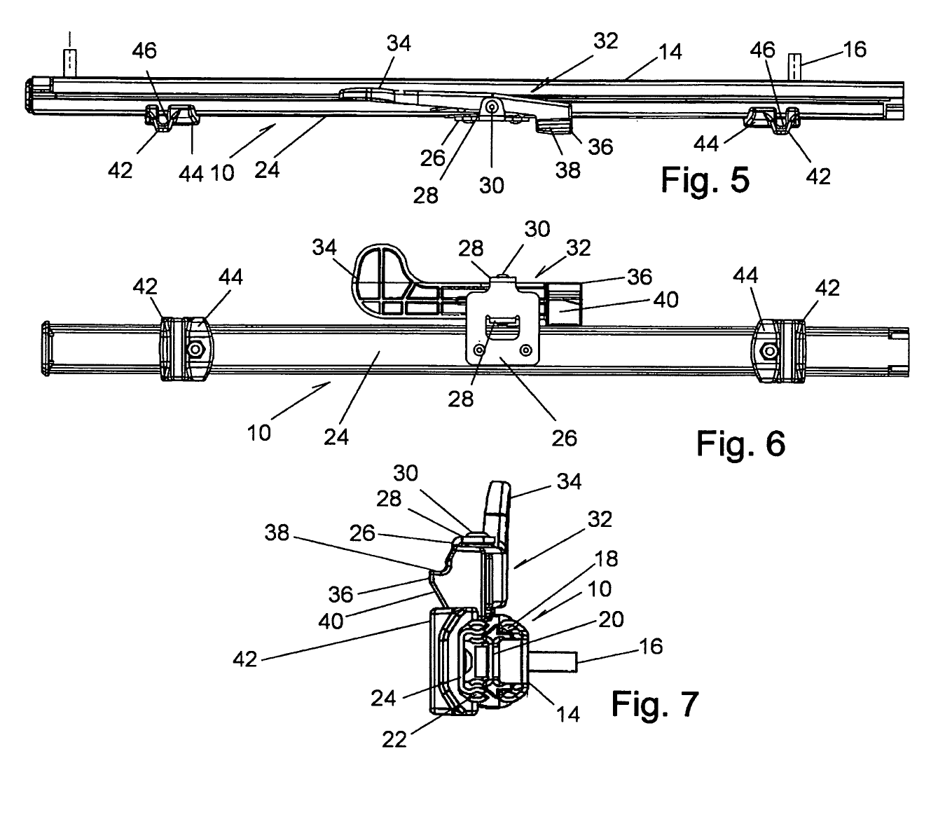

Turning in detail to the drawings, FIGS. 1 and 2 illustrate a portion of a dishwasher employing a conventional wash cavity with opposed sidewalls. Opposed horizontal slider assemblies, generally designated 10, mount an elevated wash basket, generally designated 12, to be drawn out of the wash cavity for convenient loading and unloading.

The slider assemblies 10 are conventional drawer type mechanisms used in dishwashers. The assemblies 10 are mirror images of one another. A fixed bracket 14 is bolted or otherwise affixed to the sidewall of the wash cavity. Studs 16 are illustrated for this purpose. The fixed bracket 14 is formed to include upper and lower linear races to receive bearing balls 18 along each race. Upper and lower inner races, also to receive the bearing balls 18, are defined by an inner linear bearing element 20. This inner linear bearing element 20 also defines a second set of upper and lower inner races to receive bearing balls 22. A slide member 24 defines linear upper and lower outer races to receive the bearing balls 22. With this arrangement, the slide member 24 is capable of extension from the wash cavity. The two slider assemblies 10 are placed at the same height in the dishwasher cavity and affixed to opposite walls of that cavity.

The slide members 24 each include a mounting plate 26 affixed centrally thereon. This mounting plate 26 may be affixed by screws or rivets. The body of the plate 26 extends upwardly above the level of the slide member 24 and includes two laterally extending lungs 28 having holes therethrough to receive a pivot 30 arranged along a vertical pivot axis.

Latches, generally designated 32, are pivotally mounted to the pivots 30 associated with each slide member 24. Each latch 32 includes bearing holes centrally in the body of the latch 32 to receive the pivot 30. Each latch 32 is thus pivotally mounted with a handle 34 on one side of the pivot and a catch 36 on the other. The handle 34 provides a substantial surface for actuation by the fingers of one hand. The handle 34 is displaced from the pivot axis enough so that only moderate pressure is required to actuate the latch 32. The catch 36 is also displaced from the pivot axis so that full actuation of the handle 34 will result in sufficient lateral movement of the catch 36 to disengage the wash basket 12, described below. The catch 36 includes a surface 38 which is perpendicular to the vertical pivot axis. Beneath the surface 38, the catch 36 includes a ramp 40. Each latch 32 is spring biased to extend the catch 36 inwardly of the wash cavity. A torsion spring (not visible) may be employed about the pivot axis and extending between the mounting plate 26 and the latch 32. Thus, the catch 36 is capable of allowing a latch bolt to pass across the catch from the ramp 40 and retain the latch bolt from passing the surface 38 in the other direction.

Two guides 42 are also associated with the slide member 24 of each slider assembly 10. The guides 42 are displaced from the mounting plate 26 toward the ends of the slide member 24. Each guide 42 includes a plate 44 to receive fasteners for mounting to the slide member 24. The guides 42 each further include a vertical channel 46 which is open toward the slide member 24. When each guide 42 is assembled with the slide member 24, the vertical channel 46 opens toward the slide member 24 such that a vertical member extending through the channel 46 is captured and cannot be extracted laterally therefrom. Each vertical channel 46 is shown to be at least as long as the width of the slide member 24 to mitigate the possibility of a vertical element in the channel 46 binding because of misalignment.

The elevated wash basket 12 is generally rectangular in plan and defined by widely spaced bars 48 that are formed to create the basket structure and included wash rack. These bars 48 define two opposed sides which are most adjacent the slide members 24, respectively.

On each of the opposed sides, latch bolts 50 provided by horizontal bars include a central portion extending horizontally and being laterally displaced outwardly from the wash basket 12. The central portion 52 is flanked by end portions 54, 56 which are fixed at a plurality of locations vertically displaced from one another to provide a mounting resistance moment on each side of the central portion 52 to increase strength and longevity.

Vertical elements 58, 60 are also fixed to each of the opposed sides of the wash basket 12. These vertical elements 58, 60 are constructed from formed bar as are the latch bolts 50. The vertical elements 58, 60 include a central section 62 extending vertically between an upper end 64 and a lower end 66. The central sections 62 are displaced laterally outwardly from the sides of the wash basket 12 to slidably engage the guides 42 through location in the vertical channels 46. These central sections 62 are also located adjacent if not directly at the ends of the sides of the wash basket 12 to reduce the prospect of binding of the central sections 62 in the vertical cannels 46.

The upper end 64 of each vertical elements 58, 60 meets an upper stop 68 which is a horizontal length of the bar defining the vertical elements 58, 60. The upper stops 68 extend laterally toward the sidewalls of the wash cavity across the width of the slide members 24. Lower stops (not shown) at the lower end 66 of the vertical elements 58, 60 are identically situated. The upper stops 68 and lower stops move vertically with the wash basket 12 relative to the slide members 24. As the stops extend across the slide members 24 and do not move laterally relative to the slide members 24, the stops limit the vertical motion of the wash basket 12 to a specific range.

At the extended ends of the upper stops. 68 and lower stops, upper and lower glides 70 extend parallel to the adjacent slide member 24. These glides 70 are on the far side of the adjacent slide members 24 from the wash basket 12 to approach the sidewalls of the wash cavity. These glides 70 are also defined by lengths of the bars defining the vertical elements 58, 60 and are shown here to be composed of horizontal lengths 72 and vertical lengths 74.

Anchors 76 include arms 78 which extend inwardly from the vertical lengths 74 of the upper and lower glides 70 to positions adjacent the opposed sides of the wash basket 12. These arms are also extensions of the bars making up the vertical elements 58, 60. The anchors 76 are fixed to the wash basket 12 by lengths of bars 80 extending horizontally from the inner ends of the arms 78 along the opposed sides of the wash basket 12. These lengths of bars 80 are conveniently welded to the wash basket 12.

In operation, the wash basket 12 of the disclosed embodiment may assume either of two vertical positions within the wash cavity of the dishwasher. More than two may be provided through the addition of vertically spaced latch bolts 50. In the down position, the upper stops 68 of the vertical elements 58, 60 rest against the slide members 24. The central section 62 of the vertical elements 58, 60 are retained within the vertical channels 46. Thus, the wash basket 12 can be pulled outwardly from the dishwasher cavity for loading and then returned with the slide members 24 and the basket remaining in the lower vertical position.

The wash basket 12 can be manually gripped on either side thereof and pulled upwardly relative to the dishwasher. With this motion, the central portions 52 of the latch bolts 50 encounter the ramps 40 on the catches 36. The latches 32, being spring biased, allow the catches 36 to move outwardly for the latch bolts 50 to pass. Once past the catches 36, the surfaces 38 prevent the wash basket 12 from returning to the lower position because of the engagement between the catches 36 and the latch bolts 50.

The lower stops on the vertical elements 58, 60 prevent the manual lifting of the wash basket 12 from engagement with the guides 42. Again, the wash basket 12 can be moved out of and back into the wash cavity with the slide members 24 in this vertically elevated position. To lower the wash basket 12, the handles 34 are manually pressed toward one another, inwardly toward the wash basket 12, to move the catches 36 laterally outwardly such that the surfaces 38 on the catches 36 release the latch bolts 50. The wash basket 12 can then be lowered again until the upper stops 68 again rest upon the slide members 24.

Thus, an improved dishwasher and associated mechanism for vertically locating an elevated wash basket is disclosed. While embodiments and applications of this invention have been shown and described, it would be apparent to those skilled in the art that many more modifications are possible without departing from the inventive concepts herein. The invention, therefore, is not to be restricted except in the spirit of the appended claims.

What is claimed is:

1. A dishwasher comprising
a wash cavity including opposed horizontal slider assemblies, each horizontal slider assembly having a slide member capable of extension from the wash cavity;
latches operatively mounted relative to the slide members;
guides displaced from and to either side of each of the latches and affixed to the slide members, said guides each including a vertical channel;
an elevated wash basket in the wash cavity including opposed sides, latch bolts affixed to the sides of the wash basket for engagement by the latches and vertical elements on the sides of the wash basket slidably engaging the guides in the vertical channels, respectively, each of the vertical elements being adjacent one of the ends of the opposed sides of the wash basket, respectively, each vertical element having an upper end and a lower end, an upper stop at the upper end extending across the adjacent slide member to an extended end of the upper stop and an upper glide extending parallel to the adjacent slide member at the extended end of the upper stop.

2. The dishwasher of claim 1, the vertical elements being at the ends of each opposed side of the wash basket.

3. The dishwasher of claim 1, the vertical element further having a lower stop at the lower end extending across the adjacent slide member to an extended end of the lower stop and a glide extending parallel to the adjacent slide member at the extended end of the lower stop.

4. The dishwasher of claim 3, the vertical elements being bars, the stops being horizontal lengths of the bars at the upper and lower ends of the vertical elements, the upper and lower glides being bars at the extended ends of the upper and lower stops, respectively.

5. The dishwasher of claim 4, the vertical elements further having anchors extending from the upper and lower glides to the adjacent opposed sides and affixed to the wash basket, the anchors being bars.

6. The dishwasher of claim 1, the pivot axes being vertical.

7. The dishwasher of claim 1, the latch bolts being horizontal bars.

8. The dishwasher of claim 7, the horizontal bars extending laterally outwardly from the sides of the wash basket.

9. The dishwasher of claim 7, the horizontal bars having two end portions and a central portion between the two end portions, each end portion being fixed to the wash basket at two locations vertically displaced from one another and the central portion extending horizontally and laterally outwardly from the wash basket.

10. A dishwasher comprising
a wash cavity including opposed horizontal slider assemblies, each horizontal slider assembly having a slide member capable of extension from the wash cavity;
latches pivotally mounted relative to the slide members about pivot axes, respectively, each latch including a handle on one side of the pivot axis and a catch on the other side of the pivot axis;
guides displaced to either side of each of the latches and affixed to the slide members, said guides each including a vertical channel;
an elevated wash basket in the wash cavity including opposed sides, latch bolts affixed to the sides of the wash basket for engagement by the catches and vertical elements on the sides of the wash basket slidably engaging the guides in the vertical channels, respectively, each of the vertical elements being at one of the ends of the opposed sides of the wash basket, respectively, each vertical element having an upper end and a lower end, an upper glide extending parallel to the adjacent slide member at the upper end and displaced across the adjacent slide member from the vertical element and a lower glide extending parallel to the adjacent slide member at the lower end and displaced across the adjacent slide member from the vertical element.

11. The dishwasher of claim 10, each of the vertical elements further having an upper stop at the upper end extending across the adjacent slide member to an extended end of the upper stop, a lower stop at the lower end extending across the adjacent slide member to an extended end of the lower stop, and anchors extending from the upper and lower glides to the adjacent opposed sides and affixed to the wash basket

12. The dishwasher of claim 11, the vertical elements being formed bars, the stops being horizontal lengths of the bars extending from the upper and lower ends of the vertical elements, the upper and lower glides being lengths of the bars extending from the extended ends of the upper and lower stops to glide ends and the anchors being lengths of the bars extending from the glide ends to the opposed adjacent sides.
